(19) United States
(12) Patent Application Publication
(10) Pub. No.: US 2020/0031003 A1
(43) Pub. Date: Jan. 30, 2020

(54) Automatic Adjustment and Fade Performance Hair Clippers and Method for Using the Same

(71) Applicant: Reginald Weston Brown, Murrieta, CA (US)

(72) Inventor: Reginald Weston Brown, Murrieta, CA (US)

(21) Appl. No.: 16/362,242

(22) Filed: Mar. 22, 2019

Related U.S. Application Data
(60) Provisional application No. 62/703,358, filed on Jul. 25, 2018.

(51) Int. Cl. B26B 19/38; B26B 19/04; B26B 19/06; B26B 19/20; B26B 19/26

(52) U.S. Cl. CPC B26B 19/388; B26B 19/046; B26B 19/3886; B26B 19/205; B26B 19/26; B26B 19/063

(57) ABSTRACT

Hair clippers which incorporate a microcontroller, a number of DC or stepper motors, and sensors to carry out linear movements of the guard disposed on a body of the hair clippers to ultimately perform a haircut of variable length. The microcontroller is programmed to either change the guard length incrementally at a press of a button or perform a predefined routine as determined by the user. The hair clippers have a LCD screen on the front for the user to easily view the length they are cutting at or to navigate through a number of available programs or routines. The hair clippers also include both a motorized and a manual means for the user to adjust the relative alignment of the teeth disposed on the guard, thereby permitting the user to provide an asymmetrical cut or cut the hair around a client's ears.

### RELATED APPLICATIONS

The present application is a non-provisional of U.S. Provisional Patent Application Ser. No. 62/703,358, filed on Jul. 27, 2018, which is incorporated herein by reference and to which priority is claimed pursuant to 35 USC 120.

### BACKGROUND

### Field of the Technology

The invention relates to the field of devices used for hair cutting, more specifically it relates to programmable hair clippers to capable of performing specific types haircuts.

### Description of the Prior Art

Hair clippers, both manual and electric, have long been used to cut the hair of both individuals and even animals. Typically, the hair clippers may include one or two blades, razors, or cutting elements that, when passed over the hair and scalp of individual, trim or cut the hair as it meets the oscillating razors. Hair clippers generally allow the user or barber to quickly cut the hair of a client or other individual that is all at the same length, thereby giving the client an efficient and uniform haircut.

A problem arises however when the client desires a haircut or hair style which is made up of multiple or different lengths of hair, for example a “fade” cut which starts close to the skin near the client's ear or neck and then gradually becomes longer until being at maximum length at the top of the head. Most prior hair clippers comprise multiple detachable guards, with each of the guards corresponding to a different length or segment of hair which can be cut when that specific guard is coupled or attached to the main body of the hair clippers. Specifically, each of the guards corresponds to a defined length of hair, usually between 1 mm and 16 mm (or between ¼ inch and two inches) which will remain after the hair clippers have been passed over the client's scalp. Therefore if the client wishes to have a hair style which is made of multiple or different lengths of hair, the user must attach a first guard which corresponds to a first desired length of hair to the hair clippers and then pass the clippers over the client's scalp where that particular length is desired. Then the user must stop, turn off the clippers, and replace the first guard with a second guard which corresponds to a second desired length and then pass the hair clippers over the client's scalp where the second desired length is desired. The user must repeat this process for as many different lengths are desired, thereby making the hair cutting process longer and more tedious.

Several attempts have been made in the art to make the process of cutting hair at multiple different lengths using hair clippers quicker and easier to do. Many of these attempts have included the ability to adjust the relative position of a reciprocating blade to a stationary blade disposed in the clippers. By moving the reciprocating blade, the length of hair cut may be adjusted accordingly, frequently up to a difference of 0.5 mm or ⅛ of an inch. In this fashion, the user may give in essence a “half step” or increased flexibility between each of the larger interchangeable guards. The relative distance between the stationary blade and the reciprocating blade is adjusted by actuating a manual lever or dial by the user. To change the length cut beyond the length provided by the distance between the reciprocating and stationary blades, the user still must stop and change the guard however.

Another previous attempt to solve the problem of cutting multiple different lengths of hair using hair clippers involve the movement of the guard itself. These attempts typically include adjusting the relative position of the guard to the cutting blades by manipulation of a dial or other actuation means. A problem occurs however because the dial or other actuation means require the direct manual manipulation of the user who already has their hands occupied with maneuvering the hair clippers about the client's head.

What is needed therefore is a device and method which allows the user to efficiently cut the hair of a client into multiple different lengths in a single continuous motion without the need of stopping and restarting or the manipulation of extraneous components disposed on the hair clippers itself.

### BRIEF SUMMARY

The invention includes an apparatus for providing a continuous variable length hair cut. The apparatus includes a body, a selectively adjustable guard coupled to a top portion of the body, and at least one motor coupled to the guard to move the guard in a linear direction relative to the top portion of the body. A microcontroller is also provided and coupled to the at least one motor. The microcontroller is specifically configured to control operation of the at least one motor thus the position of the guard in turn.

In one embodiment, the guard portion of the apparatus has a crosspiece and a plurality of teeth coupled to the crosspiece. The orientation of crosspiece is specifically designed to be adjustable relative to the top portion of the body. This embodiment may also further include a linear actuator that is disposed in the top portion of the body and coupled to at least one motor which is also disposed in the top portion of the body. Here, the crosspiece is coupled to the linear actuator so that actuation of the linear actuator by the at least one motor rotates the crosspiece relative to the top portion of the body. The crosspiece is preferably coupled to the linear actuator via a pivot point.

In an alternative related embodiment, the guard has a main gear disposed on its base and a plurality of secondary gears that are engaged with the main gear. A first lateral end of the crosspiece is coupled to one of the plurality of secondary gears while a second lateral end of the crosspiece is coupled to a different one of the plurality of secondary gears.

In a related embodiment, the apparatus further includes a second linear actuator which is coupled to a corresponding second motor, both of which are disposed in the top portion of the body. Here, the crosspiece is coupled to both the first and second linear actuators. This embodiment optionally includes wherein the microcontroller is coupled to the second motor and is configured to control operation of the second motor and the at least one motor independently from one another.

In another embodiment, the apparatus further includes an LCD display screen and a plurality of push buttons disposed on the body. The plurality of push buttons are connected to the microcontroller. The microcontroller is further connected to the LCD display screen to display an image thereon.

In yet another embodiment, the apparatus also includes a guard bracket which is coupled to a plurality of linear actuators. The guard is removably coupled to at least one forked element disposed on the guard bracket. Additionally, the least one motor is engaged with the guard bracket so as to move the guard bracket along the length of the plurality of linear actuators.

In a further embodiment, the top portion of the body of the apparatus comprises at least one slot defined therein to accommodate the linear movement of the at least one forked element of the guard bracket there through.

The current invention also includes a method for providing a continuous variable length hair cut. The method includes selecting a starting position of a guard relative to a body, activating a blade disposed on the body, and then passing the guard over a scalp of a client while simultaneously changing the linear position of the guard relative to the body. The hair of the client is then cut to a length determined by the linear position of the guard relative to the body as the hair makes contact with the activated blade.

In one embodiment, the method also includes selectively adjusting the alignment of a plurality of teeth of the guard relative to each other.

In another embodiment, the method further includes displaying a symbol on a display screen which represents a current linear position of the guard relative to the body.

In yet another embodiment the step of passing the guard over a scalp of a client while simultaneously changing the linear position of the guard relative to the body specifically includes changing the linear position of the guard relative to body according to a predetermined routine stored on a microcontroller. Optionally, an audio or visual signal is emitted after the guard has completed moving according to the predetermined routine.

In one specific embodiment, the step of selectively adjusting the alignment of a plurality teeth of the guard relative to each other specifically includes actuating at least one linear actuator disposed in a top portion of the body to rotate a crosspiece coupled to the plurality of teeth.

In a related embodiment, selectively adjusting the alignment of a plurality teeth of the guard relative to each other comprises rotating a plurality of gears to rotate a crosspiece which is coupled to both the plurality of gears and the plurality of teeth.

In a separate embodiment, the step of selecting a starting position of a guard relative to a body is done by activating a first motor coupled to the guard and wherein activating a blade disposed on the body is done by activating a second motor coupled to the blade.

In yet another embodiment, the step of passing the guard over a scalp of a client while simultaneously changing the linear position of the guard relative to the body specifically involves moving the guard over at least one linear actuator disposed in the body.

In another embodiment, the step of actuating at least one linear actuator disposed in a top portion of the body to rotate a crosspiece coupled to the plurality of teeth is specifically accomplished by actuating at least two linear actuators that are coupled to opposing ends of the crosspiece so to rotate each of the opposing ends in opposing directions.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a frontal view of the hair clippers forming the current invention.

FIG. 2 is a side, partial cross sectional view of the hair clippers seen in FIG. 1.

FIG. 3 is a magnified schematic view of the top portion of the hair clippers seen in FIG. 1 comprising the means for linearly moving the guard.

FIG. 4 is a top down perspective view of the guard seen in FIG. 3.

FIG. 5 is a top down perspective view of an alternative embodiment of the guard comprising an adjustable crosspiece, the crosspiece being rotated by a pair of stepper motors disposed in the top portion of the hair clippers.

FIG. 6 is a side cross sectional view of the alternative embodiment of the guard and top portion of the hair clippers seen in FIG. 5.

FIG. 7 is a top down perspective view of an alternative embodiment of the guard comprising an adjustable crosspiece, the crosspiece being rotated by a linear motor disposed in the top portion of the hair clippers.

FIG. 8 is a top perspective view of an alternative embodiment of the guard comprising an adjustable crosspiece coupled to a plurality of gears.

FIG. 9 is a bottom view of the alternative embodiment of the guard seen in FIG. 8.

FIG. 10A is a top perspective view of the alternative embodiment of the guard seen in FIG. 8 when the crosspiece is disposed in a substantially straight position thereby aligning a plurality of teeth of the guard with each other.

FIG. 10B is a top perspective view of the alternative embodiment of the guard seen in FIG. 8 when the crosspiece has been rotated to the right thereby extending the left most disposed teeth and retracting the right most disposed teeth.

FIG. 10C is a top perspective view of the alternative embodiment of the guard seen in FIG. 8 when the crosspiece has been rotated to the left thereby extending the right most disposed teeth and retracting the left most disposed teeth.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

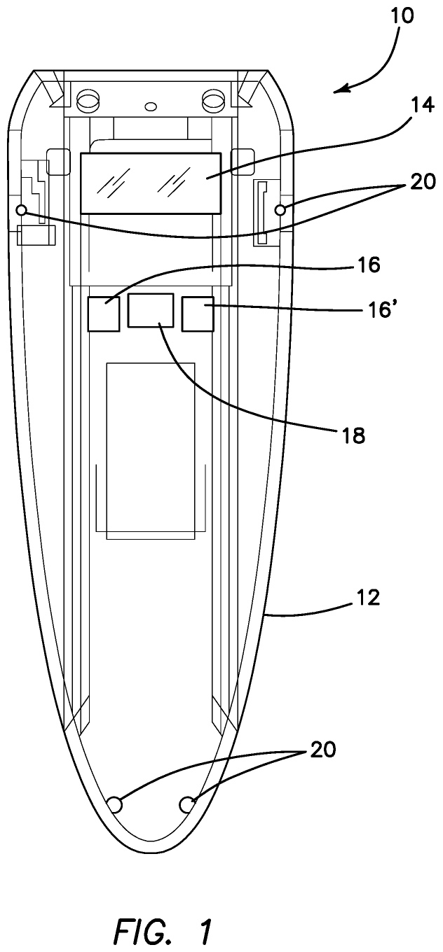

The device provided by the current invention is a hair clippers which is denoted generally with reference numeral 10 as seen in the cross sectional view of FIG. 1. The hair clippers 10 comprises a body 12 which is substantially tapered or tear drop in shape with the distal portion of the hair clippers 10 comprising the blades and the proximal portion comprising an ergonomic shape for being gripped by the user. The body 12 is preferably comprised of plastic or plastic composites, however other light weight durable materials now known or later devised may be used without departing from the original spirit and scope of the invention. The body 12 further comprises an LCD screen 14 and a plurality of push buttons 16, 16′ and main button 18 disposed in its outer surface. The body 12 is comprised of two halves held together by a plurality of fasteners 20 such as screws, brackets, or the like.

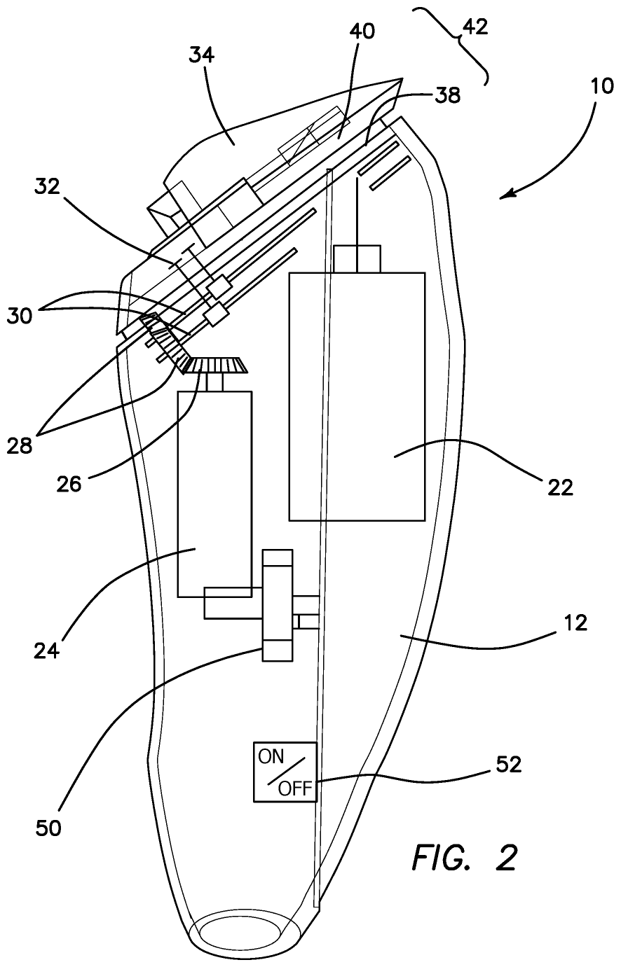

Turning to FIG. 2, a partial cross sectional side view of the hair clippers 10 may be seen. Disposed within the body 12 is a pair of motors, namely a DC motor 22 and a guard motor 24. Each motor 22, 24 is engineered to fit at a 35 degree angle. The DC motor 22 is connected to the cutting or reciprocating blade 38 to drive or oscillate the reciprocating blade 38 relative to the stationary blade 40 at a sufficient frequency so as to cut any hair disposed there between as is known in the art. The guard motor 24 is configured to drive the linear movement of a guard 34 which is removably coupled to a guard assembly 42 disposed on the distal end of the body 12. Specifically, the guard motor 24 drives a bevel gear 26 which in turn actuates a plurality of secondary gears 28. The actuation of the secondary gears 28 drives at least one linear actuator 30. A guard bracket 32 is coupled to the linear actuator 30 such that when the linear actuator 30 is activated, the guard bracket 32 will move in either direction shown by arrow 36. In one particular embodiment, the linear actuator 30 is preferably comprised of a pair of parallel ball screws, however other components suitable for linearly moving an object such as lead screws may also be used without departing from the original spirit and scope of the invention.

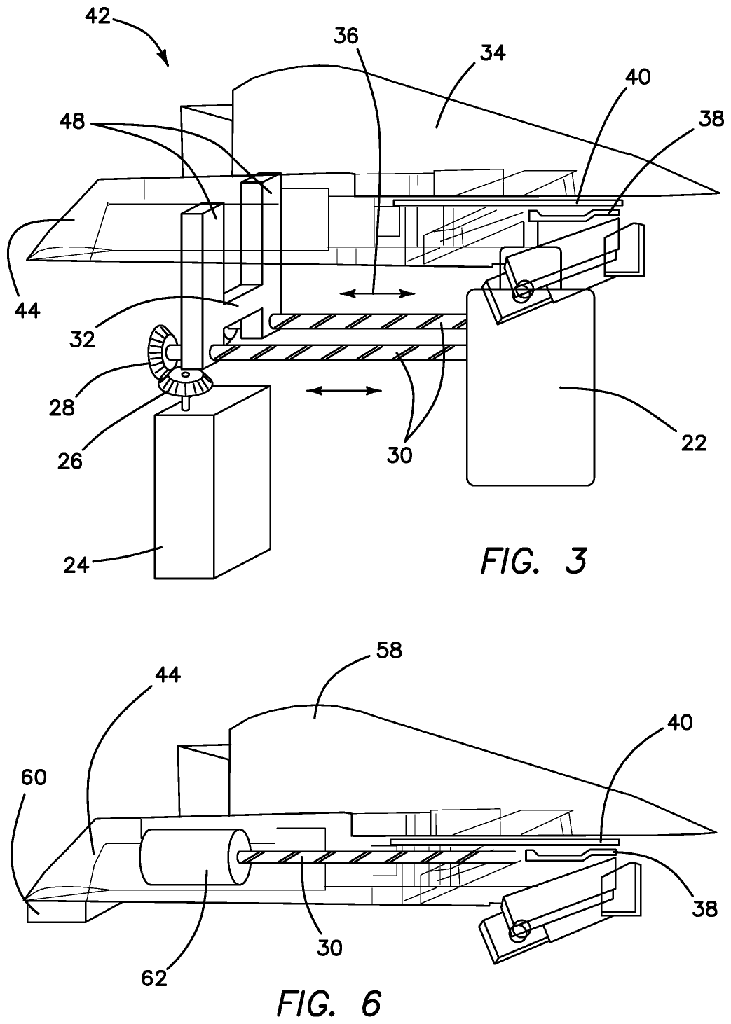

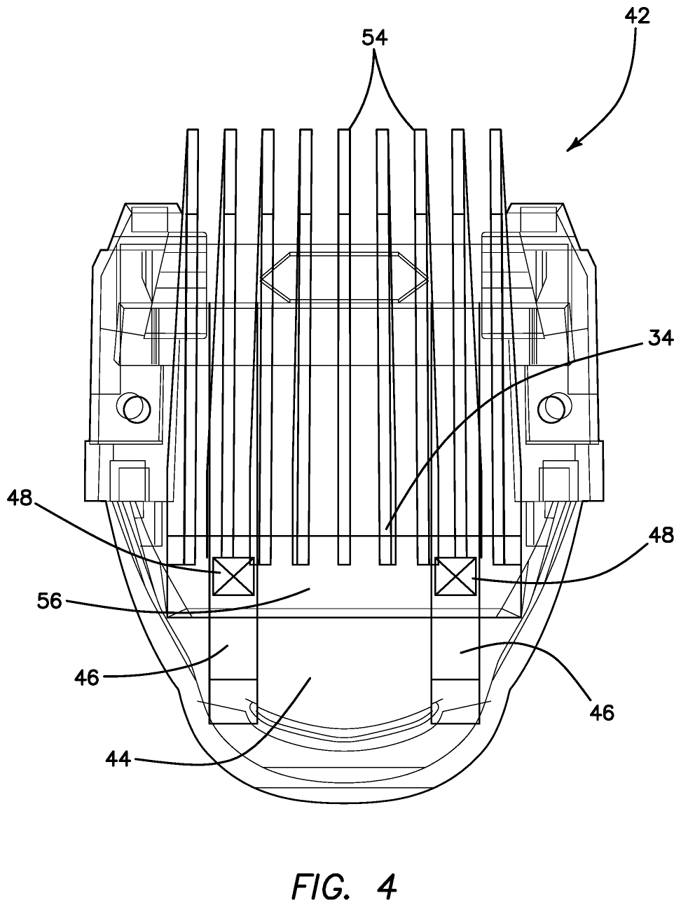

FIGS. 3 and 4 show a closer magnified view of the guard assembly 42. In one particular embodiment, the guard bracket 32 comprises a substantially bifurcated shape with a plurality of forked elements 48 which extend perpendicular relative to the linear actuator 30. Each of the forked elements 34 extend through a corresponding slot 46 defined in the top 44 of the body 12, thereby exposing the distal ends or tips of each of the forked elements 34 to the outside environment. A guard 34 is then coupled to the body 12 of the hair clippers 10 by pressing it against the exposed ends of the forked elements 48. As is known in the art, the guard 34 comprises a plurality of teeth 54 which pass through the client's hair and direct it towards the blades 38, 40 as the user moves the hair clippers 10 over the client's scalp. In the embodiment seen in FIG. 4, the individual teeth 54 of the guard 34 are coupled to a common crosspiece 56 and comprise a slope or tapered shape, making the guard 34 sufficiently sized and shaped to length to cut hair disposed around the client's ears.

A corresponding pair of apertures defined in the guard 34 accommodate the forked elements 48 in an interference or friction fit which allows the guard 34 to “snap” or “jump” into place. With the guard 34 firmly coupled to each of the forked elements 48, the guard 34 may move forward or backward through the length of the slots 46 as dictated by the movement of the forked elements 48. If desired, the user may remove the guard 34 from the hair clippers 10 by lifting up on the guard 36 until the apertures defined in the guard 34 slip off or release the forked elements 48. The user may then clean or replace the original guard 34 with a new guard if needed.

According to one specific embodiment, the hair clippers 10 is operated by actuating an on/off switch or button 52 disposed on the body 12 of the hair clippers 10. A microcontroller 50 disposed on a printed circuit board within the body 12 and which is communicated to the guard motor 24 is then activated to incrementally extend and retract the guard 36. The microcontroller 50 comprises a logic circuit which is coded or programed to selectively operate the guard motor 24 which in turn actuates the guard bracket 32 via the bevel gear 26 and secondary gears 28 to perform a routine that will result in a desired automatic movement or series of movements of the coupled guard 36. One example of a desired automatic movement may be to perform a fade haircut, i.e. a haircut comprising a short taper that “fades” into the skin. The microcontroller 50 is also communicated to the DC motor 22 which may be a rotary, magnetic, or pivot motor which controls the movement of the reciprocating blade 38 relative to the stationary blade 40. The speed of reciprocating blade 38 can be altered or adjusted to fit hair type and length.

The hair clippers 10 also comprise a plurality of H bridge transistors for all motor control. When activated, the guard motor 24 drives the bevel gear 26 and secondary gears 28 which in turn actuates the threaded ball screws 30. Each ball screw 30 is held in place by two washers and accompanied by parallel rails, therefore making linear movement and positioning of the guard 34 precise. Actuation of the ball screws 30 moves the guard bracket 32 which in turn leads to the linear movement of the guard 34 coupled to the guard bracket 32.

For the ease of descriptive purposes, moving the guard 34 so as to extend the individual teeth 54 of the guard 34 out over the edge of the top 44 of the body 12 is referred to as “extends” or “extending” the guard 34, while moving the guard 34 so as to dispose the teeth 54 over the top 44 of the body 12 is referred to as “retracts” or “retracting” the guard 34. The guard motor 24 either extends or retracts the guard 34 upon the actuation of push buttons 16, 16′, respectively. Specifically, upon the actuation of push button 16, the guard motor 24 is activated to rotate the bevel gear 26 and secondary gears 28 in a first orientation so that the guard bracket 32 moves linearly across the ball screws 30 and thereby extends the guard 34 relative to the top 44 and body 12. Conversely, actuation of push button 16′ activates the guard motor 24 so that the bevel gear 26 and secondary gears 28 will be moved in a second orientation which is opposite to the first, thereby moving the guard bracket 32 in the opposing direction across the ball screws 30 and retracting the guard 34.

The LCD screen 14 disposed on the body 12 is used to display the current operation of the hair clippers 10 and/or the settings in which the hair clippers 10 is currently configured to. When push button 16, 16′ is actuated and the guard 34 begins to move, the position of the guard 34 relative to the blades 38, 40 may tracked and displayed in real time on the screen 14. For example, if the guard 34 is originally disposed relative to the blades 38, 40 so as to deliver a 1 mm long cut, a “1” is displayed on the screen 14. When the push button 16 is actuated and the guard 34 begins to extend, the number displayed on the screen 14 changes to reflect the increase in the length of hair which will remain after the hair clippers 10 is used on the client. In this fashion, the screen 14 will progressively display a “1.2”, “1.5”, and so on until the guard 34 stops all movement which is either until the user releases the push button 16, or until the pre-programmed routine implemented by the microcontroller 50 has been completed. Conversely, upon actuation of the second push button 16′, the guard 34 will retract in the opposing direction. As the guard 34 is retracting, the screen 14 will likewise progressively display a number which corresponds to the current length of hair which will remain after it passes through the blades 38, 40. Actuation of the main or central push button 18 operates or cycles through a plurality of programs, set routines, or settings stored on the microcontroller 50 for the guard 34 to be used in. Each time the user actuates the central push button 18 the current program, routine, or setting is updated and then displayed on the screen 14 to inform the user which specific mode the hair clippers 10 is currently in. Additionally, the body 12 also comprises a button or switch on that will turn on and off the reciprocating blade 38 independently from the operation of the guard 34, or conversely, operation of the reciprocating blade 38 may be operated from the main on/off switch 52.

In a related embodiment, the microcontroller 50 of the hair clippers 10 is programmed to continually update its performance with the use of a plurality of sensors or cameras. The sensors and cameras are used to determine the angle at which the body 12 is being held and where it is located relative to the client's head.

During use, the hair clippers 10 notifies the user as to the progression or termination of the programmed routine for the guard 34. The notification may be in the form LCD lights displayed by the screen 14, or vibrations or sounds emanated from the hair clippers 10 which will help the user know when settings are implemented or complete. For example, if the microcontroller 50 is currently set to run a routine which moves the guard 34 from a “2” to a “5” over a ten second period, the hair clippers 10 may vibrate or emit an audible tone at selected points during the routine or alternatively may otherwise signal to the user that the guard 34 has reached a position corresponding to a 5 mm cut, thereby notifying the user that the cutting program is complete or terminated.

In a related embodiment, the hair clippers 10 comprises a Bluetooth® receiver or other Wi-Fi receiver will be able to connect with local Bluetooth® or Wi-Fi networks.

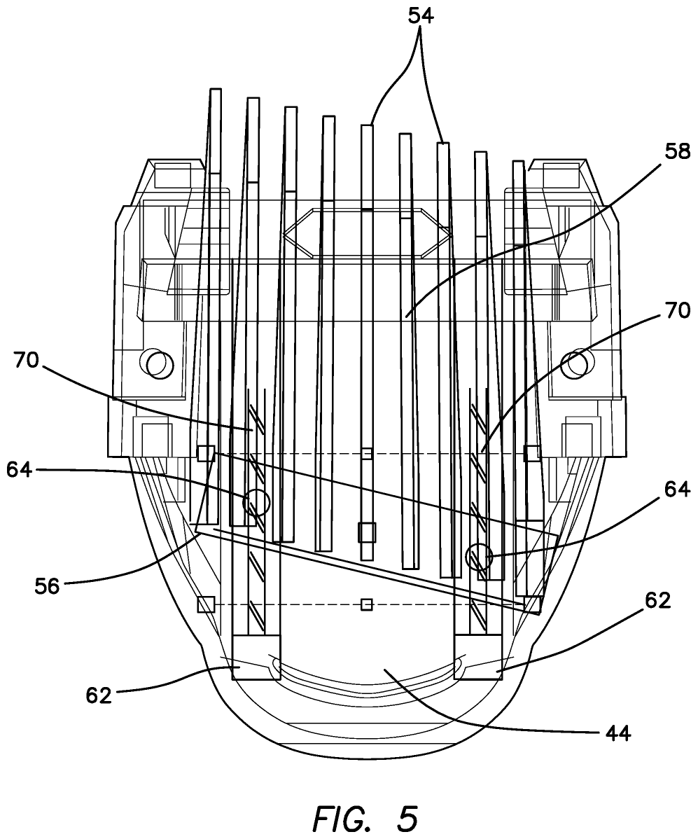

A separate embodiment of the top 44 of the body 12 and an alternative guard 58 may be seen in FIGS. 5 and 6. In this embodiment, the top 44 comprises a plurality of stepper motors 62 coupled to a corresponding plurality of linear actuators 70. The guard 58 comprises a plurality of teeth 54 which are individually and independently coupled to the crosspiece 56. The crosspiece 56 is in turn coupled to the linear actuators 70 via a pivot 64 which permits the crosspiece to turn or rotate relative to the ball screw 30 it is coupled to. The top 44 also comprises a connection bus 60 which, when the top 44 is coupled to the body 12, permits electrical and data signals to pass between the stepper motors 62 and the guard motor 24, the microcontroller 50 and/or a battery.

The embodiment seen in FIGS. 5 and 6 allows the user to selectively adjust or customize the placement of the individual teeth 54 of the guard 58 in order to provide a desired asymmetrical haircut or to cur hair around rounded features such as the client's ears. For example, the user, through the manipulation of the push buttons 16, 16′ and main push button 18, can selectively activate one or both stepper motors 62 so as to dispose the crosspiece 56 to a desired angle. Specifically, as the stepper motors 62 are activated, each pivot 64 is moved along its respective linear actuator 70. By activating one stepper motor 62 longer than any other, one lateral side of the crosspiece 56 is disposed further forward relative to the remaining lateral side of the crosspiece 56, thereby disposing the crosspiece 56 at an angle as seen in FIG. 5. Disposing the crosspiece 56 at an angle then provides an asymmetrical alignment of the teeth 54, for example the left most teeth 54 being extended further than the right most teeth 54. The user may manipulate the crosspiece 56 through a series or sequence of button presses of the push buttons 16, 16′, 18, or alternatively the stepper motors 62 may be activated together and independently via a specific routine or program as dictated by the microcontroller 50. The guard 58 may then be extended or retracted in the configuration determined by stepper motors 62 via the guard motor 24 and guard bracket 32 as disclosed above.

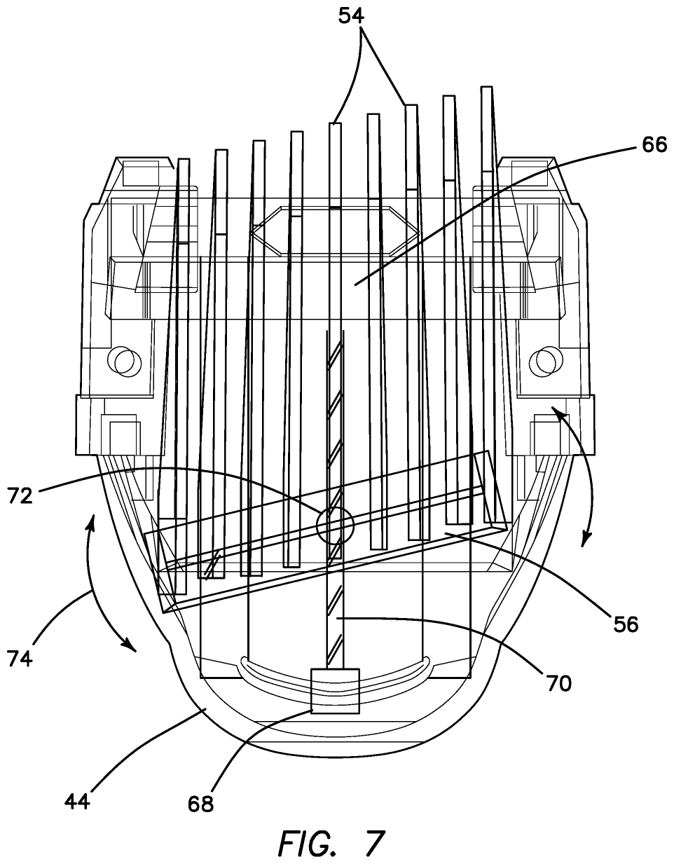

In a related embodiment seen in FIG. 7, an alternative guard 66 may be had. In this embodiment, the top 44 comprises a linear motor 68 which is coupled to a linear actuator 70. The crosspiece 56 of the guard 66 is coupled to the linear actuator 70 through a central axis point 72. A plurality of teeth 54 are also independently coupled to the crosspiece 56.

Upon actuation of the linear motor 68, the linear actuator 70 is activated which in turn rotates the crosspiece 56 about the axis point 72 in the direction shown by arrow 74. In one embodiment, by activating the linear actuator 70 in a first direction, the crosspiece 56 is rotated in a clockwise direction about the axis point 72 while activating the linear actuator 70 in a second direction rotates the crosspiece 56 in a counterclockwise direction. The user may thereby adjust the relative orientation of the crosspiece 56 to fit their specific requirements. Disposing the crosspiece 56 at an angle as seen in FIG. 7 provides an asymmetrical alignment of the teeth 54, for example right most teeth 54 being extended further than the left most teeth 54. The user may manipulate the crosspiece 56 through a series or sequence of button presses of the push buttons 16, 16′, 18, or alternatively the linear motor 68 may be activated together and independently via a specific routine or program as dictated by the microcontroller 50. The guard 66 may then be extended or retracted in the configuration determined by the linear actuator 70 via the guard motor 24 and guard bracket 32 as disclosed above.

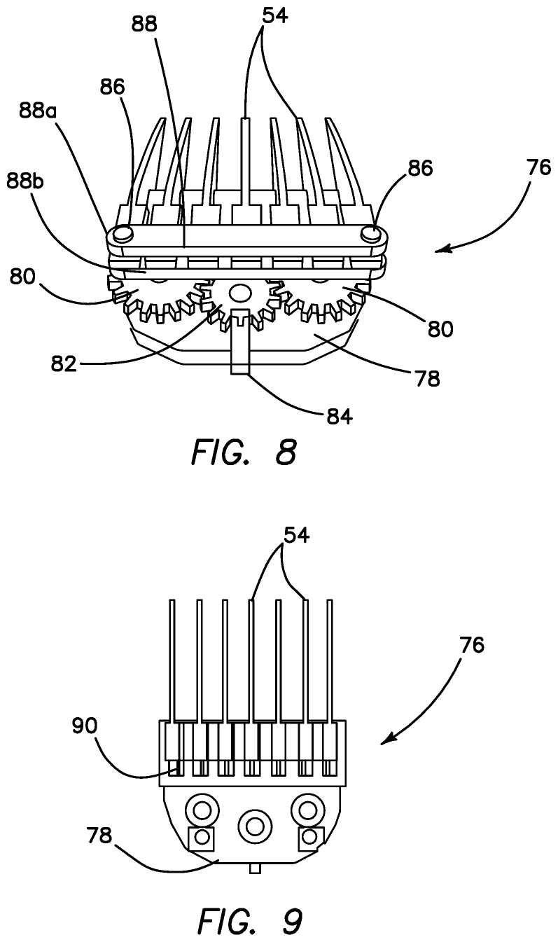

Another alternative embodiment of a guard 76 may be seen in FIGS. 8-10C. Here, the guard 76 comprises a manual means for adjusting the relative position of the teeth 54 of the guard 76. As seen in the top perspective view of FIG. 8 and the bottom view of FIG. 9, the guard 76 comprises a base 78 with a pair of secondary gears 80 and a main gear 82 each rotatably coupled thereon. The main gear 82 is disposed between and engaged with each of the secondary gears 80. Coupled to the pair of secondary gears 80 is a bottom half 88b of a crosspiece 88, specifically via a pin 86 which is threaded through the bottom half 88b and coupled to the face of each respective secondary gear 80. A top half 88a of the crosspiece 88 is also threaded by each of the pins 86. Disposed or “sandwiched” between the top half 88a and the bottom half 88b of the crosspiece 88 are the proximal ends of each of the teeth 54. The teeth 54 are further disposed in a corresponding plurality of tracks 90 defined in the base 78 as best seen in FIG. 9. Each of the plurality of teeth 54 are disposed within their respective track 90 which allows each of the teeth 54 to glide there through in a straight line independently of each other. A lever 84 is further coupled to the face of the main gear 82 which extends from the back edge of the guard 76.

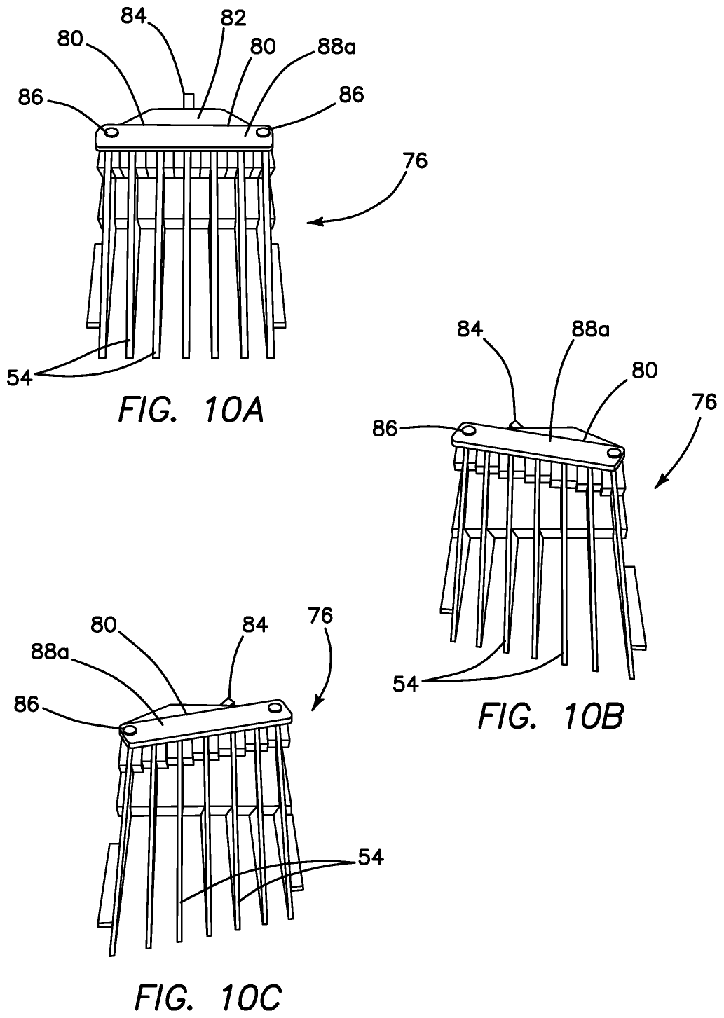

To use the manual adjusting means, the user manipulates the lever 84 by pushing it left or right, thereby rotating the main gear 82 in a clockwise or counterclockwise direction, respectively. Rotation of the main gear 82 in turn rotates the secondary gears 80 in a corresponding opposing direction. For example, if the user pushes the lever 84 as seen in FIG. 8 to the right, the main gear 82 will rotate in the counterclockwise direction which in turn rotates both secondary gears 80 in the clockwise direction. Clockwise rotation of the right most disposed secondary gear 80 will move the pin 86 proximally towards the user, thereby moving right end of the crosspiece 88 in the same direction. At the same time, the pin 86 coupled to the left most secondary gear 80 moves distally away from the user which likewise pulls the left end of the crosspiece 88 in the same direction away from the user. The overall rotation or change of orientation of the crosspiece 88 adjusts the relative alignment of the teeth 54 coupled to the crosspiece 88 by specifically retracting those teeth 54 which are disposed near the portion of the crosspiece 88 which is drawn in proximally, and extending those teeth 54 which are disposed near the portion of the crosspiece 88 which is pushed out distally. For those teeth 54 which are disposed near a center of the crosspiece 88, the relative length of those teeth 54 remains relatively unchanged no matter the current position of the crosspiece 88. For example, FIG. 10A shows the guard 76 in a straight configuration where the lever 84 is centered and the teeth 54 are substantially aligned with another. FIG. 10B shows the guard 76 after being manipulated in the manner described above, specifically with the lever 84 pushed all the way to the right (from the perspective of the user), thereby retracting the right most disposed teeth 54 and extending the left most disposed teeth 54. In both FIGS. 10A and 10B, the center most tooth 54 remains at the same length relative to the base 78 of the guard 76.

Conversely, if the user pushes the lever 84 to left, the main gear 82 rotates in the clockwise direction which in turn rotates each of the secondary gears 80 in the counterclockwise direction. This action pulls or moves the left pin 86 proximally towards the user, thereby moving left end of the crosspiece 88 in the same direction. At the same time, the pin 86 coupled to the right most secondary gear 80 moves distally away from the user which likewise pushes the right end of the crosspiece 88 in the same direction away from the user. Thus in the same manner discussed above, the overall rotation or change of orientation of the crosspiece 88 thereby adjusts the relative alignment of the teeth 54 coupled to the crosspiece 88 by specifically retracting those teeth 54 which are disposed near the portion of the crosspiece 88 which is drawn in proximally, and extending those teeth 54 which are disposed near the portion of the crosspiece 88 which is pushed out distally.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. An apparatus for providing a continuous variable length hair cut comprising:
a body;
a selectively adjustable guard coupled to a top portion of the body;
at least one motor coupled to the guard to move the guard in a linear direction relative to the top portion of the body; and
a microcontroller coupled to the at least one motor,
wherein the microcontroller is configured to control operation of the at least one motor.

2. The apparatus of claim 1 wherein the guard comprises:
a crosspiece; and
a plurality of teeth coupled to the crosspiece,
wherein the orientation of crosspiece is adjustable relative to the top portion of the body.

3. The apparatus of claim 1 further comprising:
an LCD display screen; and
a plurality of push buttons disposed on the body,
wherein the plurality of push buttons are connected to the microcontroller, and
wherein the microcontroller is connected to the LCD display screen to display an image thereon.

4. The apparatus of claim 1 further comprising a guard bracket coupled to a plurality of ball screws, wherein the guard is removably coupled to at least one forked element of the guard bracket, and wherein the at least one motor is engaged with the guard bracket to move the guard bracket along the length of the plurality of ball screws.

5. The apparatus of claim 2 further comprising:
a linear actuator disposed in the top portion of the body,
wherein the at least one motor is disposed in the top portion of the body and coupled to the linear actuator,
wherein the crosspiece is coupled to the linear actuator, and
wherein actuation of the linear actuator by the at least one motor rotates the crosspiece relative to the top portion of the body.

6. The apparatus of claim 5 further comprising:
a second linear actuator disposed in the top portion of the body; and
a second motor disposed in the top portion of the body and coupled to the second linear actuator,
wherein the crosspiece is coupled to the second linear actuator.

7. The apparatus of claim 6 wherein the microcontroller is coupled to the second motor and is configured to control operation of the second motor and operation the at least one motor independently from one another.

8. The apparatus of claim 5 wherein the crosspiece is coupled to the linear actuator by a pivot point.

9. The apparatus of claims 2 further comprising:
a main gear disposed on a base of the guard; and
a plurality of secondary gears engaged with the main gear,
wherein a first lateral end of the crosspiece is coupled to one of the plurality of secondary gears, and
wherein a second lateral end of the crosspiece is coupled to a different one of the plurality of secondary gears.

10. The apparatus of claim 4 wherein the top portion of the body comprises at least one slot defined therein to accommodate the linear movement of the at least one forked element of the guard bracket there through.

11. A method for providing a continuous variable length hair cut comprising:
selecting a starting position of a guard relative to a body;
activating a blade disposed on the body;
passing the guard over a scalp of a client while simultaneously changing the linear position of the guard relative to the body; and
cutting hair of the client to a length determined by the linear position of the guard relative to the body when the hair makes contact with the activated blade.

12. The method of claim 11 further comprising selectively adjusting the alignment of a plurality of teeth of the guard relative to each other.

13. The method of claim 11 further comprising displaying a symbol on a display screen representing a current linear position of the guard relative to the body.

14. The method of claim 11 wherein passing the guard over a scalp of a client while simultaneously changing the linear position of the guard relative to the body comprises changing the linear position of the guard relative to body according to a predetermined routine stored on a microcontroller.

15. The method of claim 14 further comprising emitting an audio or visual signal after the guard has completed moving according to the predetermined routine.

16. The method of claim 12 wherein selectively adjusting the alignment of a plurality teeth of the guard relative to each other comprises actuating at least one linear actuator disposed in a top portion of the body to rotate a crosspiece coupled to the plurality of teeth.

17. The method of claim 12 wherein selectively adjusting the alignment of a plurality teeth of the guard relative to each other comprises rotating a plurality of gears to rotate a crosspiece coupled to the plurality of gears, wherein the crosspiece is also coupled to the plurality of teeth.

18. The method of claim 11 wherein selecting a starting position of a guard relative to a body comprises activating a first motor coupled to the guard and wherein activating a blade disposed on the body comprises activating a second motor coupled to the blade.

19. The method of claim 11 wherein passing the guard over a scalp of a client while simultaneously changing the linear position of the guard relative to the body comprises moving the guard over at least one linear actuator disposed in the body.

20. The method of claim 16 wherein actuating at least one linear actuator disposed in a top portion of the body to rotate a crosspiece coupled to the plurality of teeth comprises actuating at least two linear actuators coupled to opposing ends of the crosspiece to rotate each of the opposing ends of the crosspiece in opposing directions.
